(19) United States
(12) Patent Application Publication
(10) Pub. No.: US 2013/0176514 A1
(43) Pub. Date: Jul. 11, 2013

(54) PIXEL STRUCTURE AND DISPLAY APPARATUS

(71) Applicants: Ko-ruey Jen, Taipei (TW); Chao-hui Wu, Kaohsiung (TW)

(72) Inventors: Ko-ruey Jen, Taipei (TW); Chao-hui Wu, Kaohsiung (TW)

(73) Assignee: HANNSTAR DISPLAY CORPORATION, New Taipei City (TW)

(21) Appl. No.: 13/552,675

(22) Filed: Jul. 19, 2012

(30) Foreign Application Priority Data
Jan. 11, 2012 (CN) 201210008557.0

(51) Int. Cl. G02F 1/136

(52) U.S. Cl. 349/41

(57) ABSTRACT

The present invention provides a pixel structure of a display apparatus. The pixel structure is disposed on a substrate of the display apparatus. The pixel structure comprises pixel electrode and at least one switching element electrically connected to the pixel electrode. The switching element comprises a first electrode including an opening, and a second electrode including a bend extension portion, wherein the bend extension portion extends into the opening of the first electrode. The present invention can improve the problems existing in a conventional optically compensated birefringence (OCB) mode liquid crystal display.

### FIELD OF THE INVENTION

The present invention relates to a pixel structure and a display apparatus, and more particularly to a pixel structure of an optically compensated birefringence (OCB) mode liquid crystal display apparatus.

### BACKGROUND OF THE INVENTION

Liquid crystal displays (LCDs) have been widely applied in electrical products. Currently, most of LCDs are backlight type LCDs which comprise a liquid crystal panel and a backlight module. At present, an OCB mode LCD has the advantages of a high-speed response and broad viewing angles, and thus is suitable for the LCD. However, in the OCB mode LCD, when a higher voltage difference is applied to the OCB mode liquid crystal display, the liquid crystal molecules therein will transit from a splay state to a bend state, and it is required to spend some time for the transition above.

Since the electro-optical properties of the OCB mode liquid crystal display are operated when the liquid crystal molecules therein are in the bend state, the transition time of the liquid crystal molecules from the splay state to the bend state is necessary for operating the OCB mode liquid crystal display. Therefore, there are some shortcomings existing in the conventional driving method of the OCB mode liquid crystal display.

As a result, it is necessary to provide a pixel structure and a display apparatus to solve the problems existing in the conventional technologies, as described above.

### SUMMARY OF THE INVENTION

A primary object of the present invention is to provide a pixel structure of a display apparatus. The pixel structure comprises: a pixel electrode and a switching element electrically connected to the pixel electrode, wherein the switching element comprises: a first electrode including an opening and an end portion, wherein the end portion is opposite to the opening, and two end fringes are formed at two opposite sides of the end portion, and there is an angle between the two end fringes, and the angle is in the range of 15 degrees to 150 degrees; and a second electrode including a bend extension portion, wherein the bend extension portion extends into the opening of the first electrode.

In one embodiment of the present invention, there is a predetermined angle between the bend extension portion and a rubbing direction of the pixel structure, and the predetermined angle is at least less than 90 degrees.

In one embodiment of the present invention, lateral electric fields are formed between the opening of the first electrode and the bend extension portion, and the lateral electric fields comprise a first lateral electric field and second lateral electric fields, and the first lateral electric field is formed between the bottom of the opening and the top of the bend extension portion, and the second lateral electric fields are formed between two inner sidewalls of the opening and the bend extension portion.

In one embodiment of the present invention, the lateral electric fields are further formed between the first electrode and another adjacent pixel electrode, the lateral electric fields further comprise a third lateral electric field and a fourth lateral electric field, and the third lateral electric field is formed between one of the end fringes and the adjacent pixel electrode, and the fourth lateral electric field is formed between another one of the end fringes and an adjacent data line.

In one embodiment of the present invention, the predetermined angle is in the range of 7.5 degrees to 75 degrees.

In one embodiment of the present invention, the predetermined angle is 45 degrees.

In one embodiment of the present invention, the second electrode further includes a connection portion, and a direction of the connection portion is similar to the rubbing direction.

In one embodiment of the present invention, the angle between the two end fringes is 90 degrees.

In one embodiment of the present invention, the pixel structure is formed in a pixel region, and an aperture ratio of the pixel region is greater than 40%.

Another object of the present invention is to provide a display apparatus. The display apparatus comprises: a first substrate; a second substrate; and a liquid crystal layer sandwiched between the first substrate and the second substrate; wherein the first substrate comprises a plurality of pixel structures, and each of the pixel structures comprises: a pixel electrode; and a switching element electrically connected to the pixel electrode, wherein the switching element comprises: a first electrode including an opening and an end portion, wherein the end portion is opposite to the opening, and two end fringes are formed at two opposite sides of the end portion, and there is an angle between the two end fringes, and the angle is in the range of 15 degrees to 150 degrees; and a second electrode including a bend extension portion, wherein the bend extension portion extends into the opening of the first electrode.

The pixel structure of the display apparatus of the present invention can form lateral electric fields with different directions in pixel regions with limited space, so as to form seeds of liquid crystal molecules therein for greatly reducing a phase transition time of the liquid crystal molecules from the splay state to the bend state, and enhancing the aperture ratio of each of the pixel regions to improve the display quality of the display apparatus,

The structure and the technical means adopted by the present invention to achieve the above and other objects can be best understood by referring to the following detailed description of the preferred embodiments and the accompanying drawings.

### DESCRIPTION OF THE DRAWINGS

FIG. 1 is a schematic diagram showing a display apparatus according to a preferred embodiment of the present invention;

FIG. 2 is a schematic diagram showing a first substrate of the display apparatus according to the preferred embodiment of the present invention; and

FIG. 3 is a schematic diagram showing a pixel structure of the display apparatus according to the preferred embodiment of the present invention.

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

Referring to FIG. 1, a schematic diagram showing a display apparatus according to a preferred embodiment of the present invention is illustrated. The display apparatus of the present invention may be an OCB mode liquid crystal display apparatus which comprises a backlight module 101 and a liquid crystal display panel 100. The backlight module 101 is configured to provide backlight for the liquid crystal display panel 100.

Referring to FIG. 1 again, the liquid crystal display panel 100 of the present embodiment may comprise a first substrate 110, a second substrate 120, a liquid crystal layer 130, a first polarizer 140 and a second polarizer 150. The first substrate 110 and the second substrate 120 may be glass substrates or flexible transparent substrates. In this embodiment, the first substrate 110 may be a thin film transistor (TFT) array substrate, and the second substrate 120 may be a color filter (CF) substrate. It is worth mentioning that the CF and the TFT array may be arranged on the same substrate in other embodiments. The liquid crystal layer 130 is sandwiched between the first substrate 110 and the second substrate 120. The first polarizer 140 is disposed on one side of the first substrate 110 and opposite to the liquid crystal layer 130 (as a light-incident side of the first substrate 110). The second polarizer 150 is disposed on one side of the second substrate 120 and opposite to the liquid crystal layer 130 (as a light-emitting side of the second substrate 120).

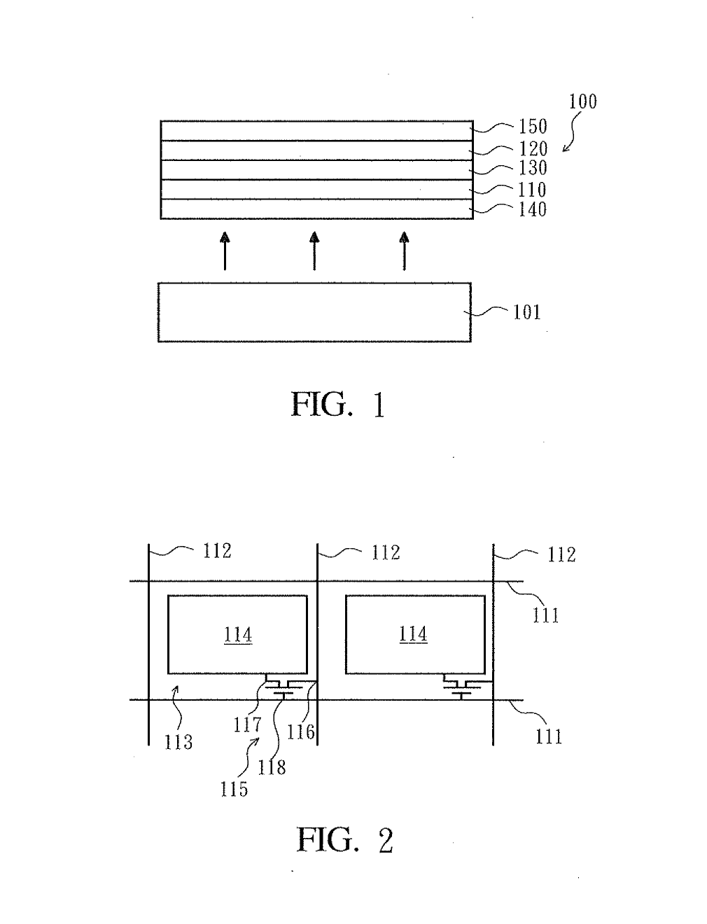

Referring to FIG. 2, a schematic diagram showing the first substrate of the display apparatus according to the preferred embodiment of the present invention is illustrated. The first substrate of the present embodiment comprises a plurality of gate lines 111, a plurality of data lines 112 and a plurality of pixel structures 113. The gate lines 111 and the data lines 112 are arranged in a crisscross pattern, thereby forming pixel regions arranged in a matrix manner, and the pixel structures 113 are disposed in the pixel regions. Each of the pixel structures 113 comprises a pixel electrode 114 and at least one switching element 115. The pixel electrode 114 is preferably made of electrically conductive and transparent material, such as ITO, IZO, ITZO, AZO, GZO, ZnO or PEDOT. The switching element 115 is electrically connected to the pixel electrode 114, the gate lines 111 and the data lines 112.

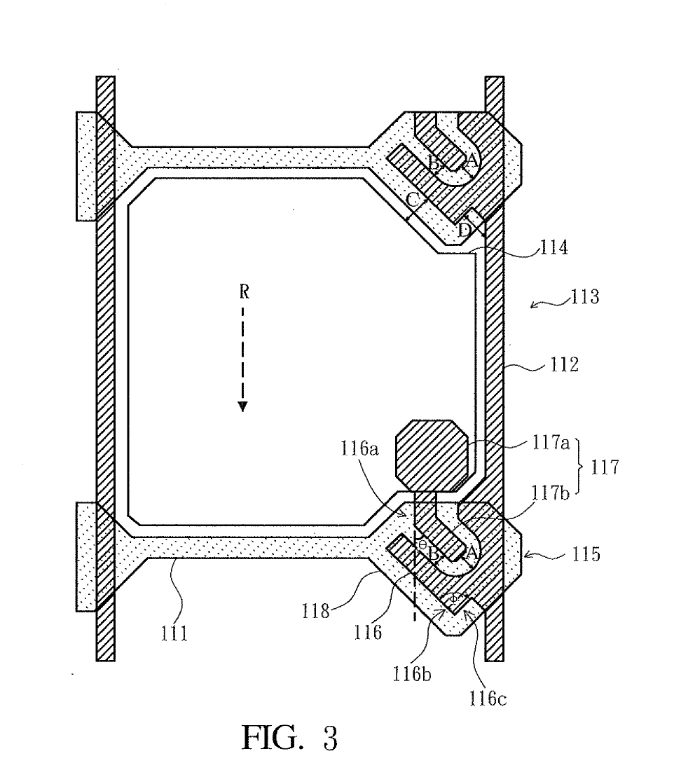

Referring to FIG. 2 and FIG. 3, FIG. 3 is a schematic diagram showing the pixel structure of the display apparatus according to the preferred embodiment of the present invention. The switching element 115 of the pixel structures 113 of the present embodiment may be a TFT element, which comprises a first electrode 116, a second electrode 117 and a third electrode 118. The first electrode 116 may be a source electrode electrically connected to the data lines 112. The second electrode 117 may be a drain electrode electrically connected to the pixel electrode 114. The third electrode 118 may be a gate electrode electrically connected to the gate lines 111. The first electrode 116 includes an opening 116a facing the corresponding pixel electrode 114. The first electrode 116 is preferably a U-shaped opening and further includes a V-shaped or wedge-shaped end portion opposite to the opening 116a. Two end fringes 116b, 116c are formed at two opposite sides of the end portion, and there is an angle ψ between the two end fringes 116b, 116c. Moreover, there is a space existing between the end fringes 116b, 116c and the pixel electrode 114.

Referring to FIG. 3 again, the second electrode 117 of the switching element 115 includes a connection portion 117a and a bend extension portion 117b. The connection portion 117a is connected to the pixel electrode 114. The bend extension portion 117b extends from the connection portion 117a into the opening 116a of the first electrode 116. Furthermore, there is a predetermined angle θ between the bend extension portion 117b and a rubbing direction R (i.e. an alignment direction of liquid crystal molecules of the liquid crystal layer 130) of the pixel structures 113, and the predetermined angle θ is at least less than 90 degrees. In this embodiment, a direction of the connection portion 117a is similar to the rubbing direction R. That is, there is also the predetermined angle θ between the connection portion 117a and the bend extension portion 117b. In this case, the shape of the opening 116a of the first electrode 116 preferably corresponds to the extension shape of the bend extension portion 117b, so as to form a channel (or space) with a constant width between the opening 116a and the bend extension portion 117b.

Referring to FIG. 3 again, when driving the display apparatus of the present embodiment, lateral electric fields are first formed by modulating the potential difference between the opening 116a of the first electrode 116 and the bend extension portion 117b of the second electrode 117, so as to form seeds of the liquid crystal molecules therein, wherein the seeds of the liquid crystal molecules are in a bend state. Subsequently, an initialization process to provide a vertical electric field is formed by modulating the potential difference between the pixel electrode 114 of the first substrate 110 and a common electrode (not shown) of the second substrate 120, so as to result in the propagation of the bend state of the liquid crystal molecules transitioned from the seeds therein, thus allowing the liquid crystal molecules to transit from a splay state to the bend state. In this embodiment, the lateral electric fields between the opening 116a and the bend extension portion 117b comprise a first lateral electric field A and second lateral electric fields B. The first lateral electric field A is formed between the bottom of the opening 116a and the top of the bend extension portion 117b. The second lateral electric fields B are formed between two inner sidewalls of the opening 116a and the bend extension portion 117b. In this case, the direction of the first lateral electric field A may be vertical to the direction of the second lateral electric field B. At this time, there is the predetermined angle θ between the direction of the first lateral electric field A and the rubbing direction R, and there is an angle of (90-θ) between the direction of the second lateral electric field B and the rubbing direction R.

Therefore, the lateral electric fields with different directions can be formed in the pixel structures 113 of the present embodiment, so as to form the seed of the liquid crystal molecules for greatly reducing the phase transition time of the liquid crystal molecules from the splay state to the bend state.

In addition, referring to FIG. 3 again, in this embodiment, the lateral electric fields are further formed between the first electrode 116, the pixel electrode 114 and the data lines. The lateral electric fields between the first electrode 116 and the adjacent pixel electrode 114 comprise a third lateral electric field C and a fourth lateral electric field D. As shown in FIG. 3, the third lateral electric field C is formed between the end fringe 116b and the adjacent pixel electrode 114, and the fourth lateral electric field D is formed between the end fringe 116a and the adjacent data line 112 or the pixel electrode 114. In this case, the direction of the first lateral electric field A can be substantially similar to the direction of the fourth lateral electric field D, and the direction of the second lateral electric field B can be substantially similar to the direction of the third lateral electric field C. Therefore, with the use of the pixel structures 113 of the preferred embodiment, the numerous lateral electric fields can be formed in the pixel regions with limited space for greatly reducing the phase transition time of the liquid crystal molecules from the splay state to the bend state.

In an embodiment, with the use of the pixel structures 113, an aperture ratio of each of the pixel regions can be increased and greater than 40% for enhancing display quality of the display apparatus, and particularly suitable for the display apparatus with a small size. Preferably, in one embodiment, the aperture ratio of each of the pixel regions can be substantially equal to or greater than 42%.

In one embodiment, when the predetermined angle θ between the bend extension portion 117b and the rubbing direction R is in the range of 7.5 degrees to 75 degrees, the lateral electric fields with different directions formed in the pixel structures 113 can be enhanced. Preferably, the predetermined angle θ is 45 degrees.

In one embodiment, when the angle ψ between the two end fringes 116b, 116c of the first electrode 116 is in the range of 15 degrees to 150 degrees, the lateral electric fields with different directions formed in the pixel structures 113 can be enhanced. Preferably, the angle y between the two end fringes 116b, 116c is 90 degrees.

As described above, with the use of the pixel structure of the display apparatus of the present invention, the lateral electric fields with different directions can be formed in the pixel regions with limited space for greatly reducing the phase transition time of the liquid crystal molecules from the splay state to the bend state, and enhancing the aperture ratio of each of the pixel regions (greater than 40%), so as to improve the display quality of the display apparatus,

The present invention has been described with a preferred embodiment thereof and it is understood that many changes and modifications to the described embodiment can be carried out without departing from the scope and the spirit of the invention that is intended to be limited only by the appended claims.

1. A pixel structure of a display apparatus, comprising:
a pixel electrode; and
a switching element electrically connected to the pixel electrode, wherein the switching element comprises:
a first electrode including an opening and an end portion, wherein the end portion is opposite to the opening, and two end fringes are formed at two opposite sides of the end portion, and there is an angle between the two end fringes, and the angle is in the range of 15 degrees to 150 degrees; and
a second electrode including a bend extension portion, wherein the bend extension portion extends into the opening of the first electrode.

2. The pixel structure according to claim 1, wherein there is a predetermined angle between the bend extension portion and a rubbing direction of the pixel structure, and the predetermined angle is at least less than 90 degrees.

3. The pixel structure according to claim 2, wherein lateral electric fields are formed between the opening of the first electrode and the bend extension portion, and the lateral electric fields comprise a first lateral electric field and second lateral electric fields, and the first lateral electric field is formed between the bottom of the opening and the top of the bend extension portion, and the second lateral electric fields are formed between two inner sidewalls of the opening and the bend extension portion.

4. The pixel structure according to claim 3, wherein the lateral electric fields are further formed between the first electrode and another adjacent pixel electrode, the lateral electric fields further comprise a third lateral electric field and a fourth lateral electric field, and the third lateral electric field is formed between one of the end fringes and the adjacent pixel electrode, and the fourth lateral electric field is formed between another one of the end fringes and an adjacent data line.

5. The pixel structure according to claim 2, wherein the predetermined angle is in the range of 7.5 degrees to 75 degrees.

6. The pixel structure according to claim 5, wherein the predetermined angle is 45 degrees.

7. The pixel structure according to claim 2, wherein the second electrode further includes a connection portion, and a direction of the connection portion is similar to the rubbing direction.

8. The pixel structure according to claim 1, wherein the angle between the two end fringes is 90 degrees.

9. The pixel structure according to claim 1, wherein the pixel structure is formed in a pixel region, and an aperture ratio of the pixel region is greater than 40%.

10. A display apparatus, comprising:
a first substrate;
a second substrate; and
a liquid crystal layer sandwiched between the first substrate and the second substrate;
wherein the first substrate comprises a plurality of pixel structures, and each of the pixel structures comprises:
a pixel electrode; and
a switching element electrically connected to the pixel electrode, wherein the switching element comprises:
a first electrode including an opening and an end portion, wherein the end portion is opposite to the opening, and two end fringes are formed at two opposite sides of the end portion, and there is an angle between the two end fringes, and the angle is in the range of 15 degrees to 150 degrees; and
a second electrode including a bend extension portion, wherein the bend extension portion extends into the opening of the first electrode.
